(19) United States
(12) Patent Application Publication
(10) Pub. No.: US 2008/0020332 A1
(43) Pub. Date: Jan. 24, 2008

(54) Device, System And Method For Operating A Digital Radiograph

(76) Inventors: David Lavenda, Tel Mond (IL); Ronald La Venda, Framingham, MA (US); Michal Devir, Kfar Vitkin (IL); David Arlinsky, Atlit (IL); Gershon Goldenberg, Carcur (IL)

Correspondence Address: EMPK & Shiloh, LLP, 116 JOHN ST,, SUITE 1201, NEW YORK, NY, 10038, US

(21) Appl. No.: 10/583,905

(22) PCT Filed: Jan. 1, 2006
(86) PCT No.: PCT/IL06/00006

§ 371 Date: Jun. 28, 2007

Related U.S. Application Data
(60) Provisional application No. 60/639,987, filed on Dec. 30, 2004.
(60) Provisional application No. 60/693,078, filed on Jun. 23, 2005.

(51) Int. Cl. G03C 1/00

(52) U.S. Cl. 430/495.1

(57) ABSTRACT

A handheld radiographic device is provided, the device may include an X-ray detector adapted to provide a digital radiographic frame of a dynamic image of an object under investigation, a position determination subsystem adapted to provide position data associated with a digital radiographic frame and an image processing controller adapted to combine multiple radiographic frames using the position data associated with each of the radiographic frames and thus to produce a static image. Moreover, a method is provided for producing a static image from multiple radiographic frames using a handheld radiographic device.

### BACKGROUND

The number of radiological examinations emanating from interactions at medical “points of care” is staggering. Patients involved in accidents or suffering other forms of trauma are often in need of timely radiological examinations at the initial point of medical contact (for example, accident site, trauma centers, health clinic and physician's office).

The lack of on-site examinations results in a reduced quality of treatment and higher costs of health care. Furthermore, the need to send patients to radiological centers or hospitals for evaluations reduces a physician's revenue stream.

Fluoroscopy is a dynamic radiographic technology. Presently, there exist devices that employ X-rays or other types of radiation to produce fluoroscopic or transitory images and radiographic images for diagnostic purposes. These devices are bulky and heavy and are fixed in location. Most of such units, by their nature, produce large dosage of X-rays and consume large amounts of power necessitating specialized electrical power sources and, for “mobile” units, heavy and bulky arrays of batteries. Even so called “portable” or “mini” units typically weigh over 100 kg and are portable only by the virtue of special carts that facilitate limited movement.

Furthermore, many X-ray systems currently in use for both fluoroscopy and radiography employ high intensity x-radiation, which high intensity is dictated, in large part, by the relatively low gain or limited degree of light amplification provided by conventional image intensification techniques. The high radiation intensities employed in these systems also require the use of X-ray tubes employing large area focal spots since otherwise the high beam currents would generate too much heat and lead to rapid deterioration of the tube anode (unless cooled by a bulky cooling mechanism). X-ray tubes employing large area focal spots necessitate operation at long source to image distances in order to maintain satisfactory image resolution or definition. As such, these systems must be operated by specialized personnel working in Lead-shielded environments, in order to protect the patient, the operator, and other people located in the surrounding environment.

Also, it is not practical to “scale down” existing solutions, in order to fulfill the needs for “on site” radiological examinations. This is because a scaled down unit would produce a field of view that is too small to be practical for most applications. Such a device already appears in the prior art, but it does not fulfill the requirements of point of care applications.

Typically, X-ray C-arm devices which are named C-arms because of the representative shape of the assembly (which resembles the letter “C”) may be mounted on a stationary assembly that facilitates manipulation in order to view a wide range of body parts. These assemblies are by nature stationary and are typically housed in a specially-designed radiology center. “Portable” or “mini” C-arms that exist in the market (GE Lunar, OEC, Xitec, Toshiba and others) are devices that are mounted on movable carts. They typically weigh hundreds of pounds and require a truck to move them from place to place. Other manufactured portable C-arms (manufactured by Lixi Corp., for example) are powered by radiologically-active isotopes. These devices are unwieldy and are impractical for use in the field.

There is thus a need to develop improved portable X-ray radiographs for use at the initial point of medical intervention.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

In one embodiment of the present disclosure, a handheld radiographic device is provided, the device may include an X-ray detector adapted to provide a digital radiographic frame of a dynamic image of an object under investigation, a position determination subsystem adapted to provide position data associated with a digital radiographic frame and an image processing controller adapted to combine multiple radiographic frames using the position data associated with each of the radiographic frames and to produce a static image. In another embodiment, the controller may further be adapted to produce a dynamic image superimposed over a static image.

In another embodiment of the present disclosure, a system is provided, the system may include a handheld radiographic device, the device may include an X-ray detector adapted to provide a digital radiographic frame of a dynamic image of an object under investigation, a position determination subsystem adapted to provide position data associated with a digital radiographic frame and an image processing controller adapted to combine multiple radiographic frames using the position data associated with each of the radiographic frames and to produce a static image. In another embodiment, the controller may further be adapted to produce a dynamic image superimposed over a static image.

In another embodiment of the present disclosure, a method is provided for producing a static image from multiple radiographic frames using a handheld radiographic device, the method may include producing a digital radiographic frame of a dynamic image of an object under investigation, providing position data associated with the digital radiographic frame and combining multiple radiographic frames using the position data associated with each of the radiographic frames to produce a static image. In another embodiment, the method may further include producing a dynamic image superimposed over a static image.

### BRIEF DESCRIPTION OF THE DRAWINGS

FIG. 1 is a schematic illustration of a handheld radiographic device, according to some embodiments of the present disclosure;

FIG. 2 (A-B) are schematic block diagrams of the system, according to some embodiments of the present disclosure;

FIG. 3 (A-C) are schematic diagrams of the system, according to some embodiments of the present disclosure;

FIG. 4 (A-B) are schematic diagrams of the system, according to some embodiments of the present disclosure;

FIG. 5 is a schematic diagram of the system (A) and a possible radiographic frame (B) obtained by the system, according to some embodiments of the present disclosure;

FIG. 6 is a schematic diagram of the system (A) and a possible static image (B) obtained by the system, according to some embodiments of the present disclosure;

FIG. 7 is a schematic diagram of the system (A) and a possible dynamic image superimposed on a static image (B) obtained by the system, according to some embodiments of the present disclosure;

FIG. 8 illustrates a flow chart of a method, according to some embodiments of the present disclosure; and

FIG. 9 is a schematic diagram of the robotic arm, according to some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

The following description is presented to enable one of ordinary skill in the art to make and use the disclosure as provided in the context of a particular application and its requirements. Various modifications to the described embodiments will be apparent to those with skill in the art, and the general principles defined herein may be applied to other embodiments. Therefore, the present disclosure is not intended to be limited to the particular embodiments shown and described, but is to be accorded the widest scope consistent with the principles and novel features herein disclosed. In other instances, well-known methods, procedures, and components have not been described in detail so as not to obscure the present disclosure.

Unless specifically stated otherwise, as apparent from the following discussions, it is appreciated that throughout the specification discussions utilizing terms such as “processing”, “computing”, “calculating”, “determining” and the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In one embodiment of the present disclosure, a handheld radiographic device is provided, the device may include an X-ray detector adapted to provide a digital radiographic frame of a dynamic image of an object under investigation, a position determination subsystem adapted to provide position data associated with a digital radiographic frame and an image processing controller adapted to combine multiple radiographic frames using the position data associated with each of the radiographic frames and to produce a static image.

In another embodiment of the present disclosure, a system is provided, the system may include a handheld radiographic device, the device may include an X-ray detector adapted to provide a digital radiographic frame of a dynamic image of an object under investigation, a position determination subsystem adapted to provide position data associated with a digital radiographic frame and an image processing controller adapted to combine multiple radiographic frames using the position data associated with each of the radiographic frames and to produce a static image. In another embodiment, the controller may further be adapted to produce a dynamic image superimposed over a static image. In another embodiment, the controller may further be adapted to produce a dynamic image superimposed over a static image, wherein the dynamic image is superimposed on the correct place on the static image. In another embodiment, the correct place may refer to the place of a certain partial image in a larger image.

According to some embodiments, the device may include a C-arm shaped element. According to some embodiments, the device may be structured as a C-arm (or a micro C-arm) which may incorporate any one of the following design characteristics:

The device may be small enough to be portable. According to other embodiments, the device may be self-contained. In some embodiments, the terms “portable device” or “handheld device” may refer to a device adapted to being carried, deployed, and operated by non-specialized radiation personnel. In other embodiments, self-contained may refer to a system which is operational without the need for additional external elements (other than those provided in this document).

The device may provide the energy levels and resolution necessary generate images static and dynamic fluoroscopic images that are useful for the application.

The device may be safe for use by non-specialized personnel in non-shielded environments, for a number of examinations that are routinely performed by such personnel.

According to some embodiments, the terms “radiography”, “radiograph” or “radiographic” may refer to the creation of images by exposing an image receptor to X-ray. According to some embodiments, the terms “fluoroscopy”, “fluoroscope” or “fluoroscopic” may refer to an imaging technique for obtaining real-time images of the internal structures of an object by irradiating the object with X-ray irradiation.

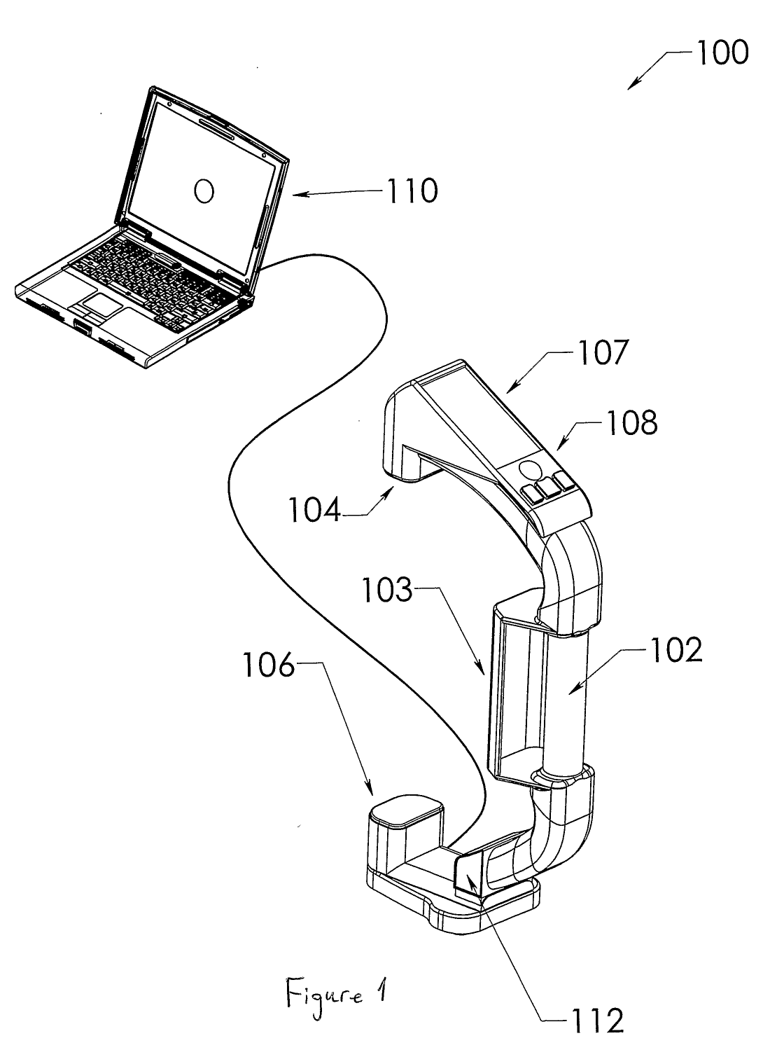

Reference is now made to FIG. 1, which is a schematic illustration of an exemplary handheld radiographic device, structured as a micro C-arm portable fluoroscopic X-ray device (100), according to some embodiments of the present disclosure. The device includes a grip handle (102) with a radiation cover shield (103) connected on one side to an X-ray source (104) and on the other side to an X-ray detector (106). The upper part of the C-arm includes an onboard viewing monitor (107) and a control panel (108) or the data may be transmitted to a remote monitor or storage medium (110). The lower part of the C-arm includes a power supply element (112). The system's power supply may or may not be incorporated into the C-arm itself.

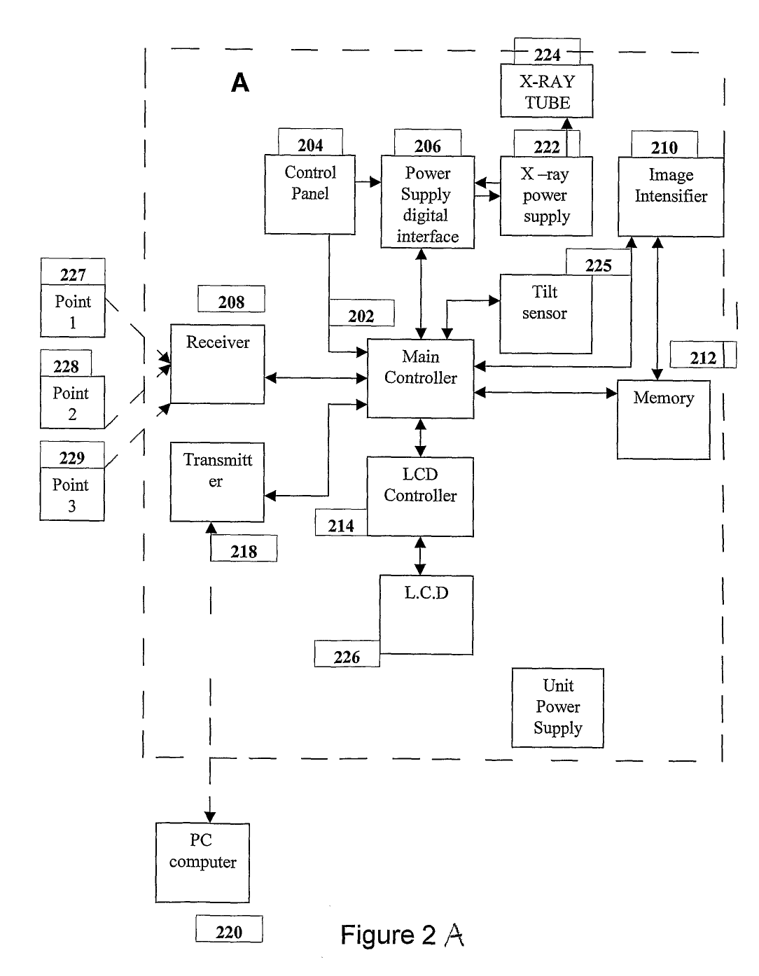

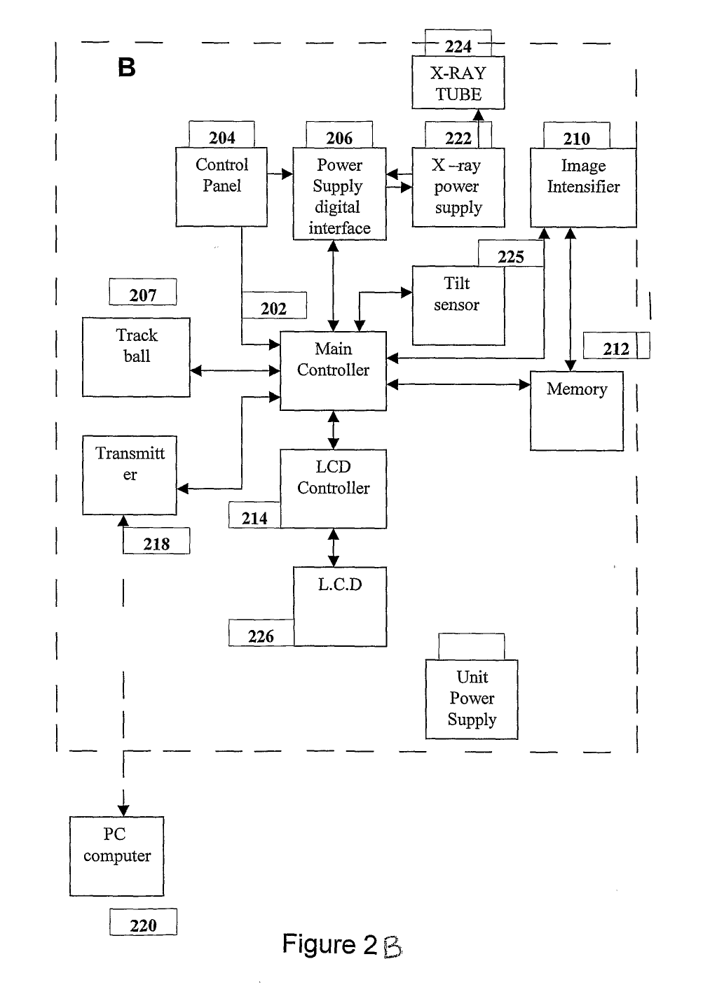

Reference is now made to FIG. 2A, which is a schematic block diagram (200) of the system, according to some embodiments of the present disclosure. The system may include, according to some exemplary embodiments, a main controller (202) connected to a control panel (204), a power supply digital interface (206), a receiver (208), an image intensifier (210), a memory (212), an LCD controller (214), a tilt sensor (215) and a transmitter (218) which may transmit a signal to a remote receiving device, for example, a PC (220). The control panel (204) is connected to the digital interface (206). The power supply digital interface (206) combines between main controller (202) and the X-ray power supply (222) which is connected to an X-ray tube (224). The image intensifier (210) is also connected to the memory (212). The LCD controller (214) also connects to an LCD (226).

In operation, according to some embodiments, the main controller (202), which is adapted to manage the entire system and regulate the flow of information from the system memory to the output device, after receiving a signal from the control panel (204), signals the digital interface (206) to activate the X-ray power supply (222) which results in emission of X-ray radiation by the an X-ray tube (224). The X-ray radiation may penetrate an object under inspection and impinge upon the image intensifier (detector) (210), which includes a surface sensitive to X-ray radiation and is capable of converting X-ray energy into electrical signals, whereby the electrical signals are used to build multiple radiographic frames of the object under observation. Each digital radiographic frame obtained may be transferred to the memory (212). In addition, each digital radiographic frame is associated with data relating to its relative position within the whole image of the object under observation, which data is obtained by the receiver (208) which receive signals from three transmitters (227, 228, 229) located in three different positions. The tilt angle may be obtained using the tilt sensor (215). The main controller (202) may be adapted to operate as an image processing controller and may be adapted to combine multiple the radiographic frames using the position data associated with each of the radiographic frames, to produce a static image and to produce a dynamic image superimposed over a static image. The signals representing the images may be transmitted to a remote receiving device, for example, a PC computer (220). The signals representing the images may also be transmitted to an LCD controller (214) and presented on an LCD (226). The LCD may also show the system's menus related to ongoing system operation and displays the object under observation when the system is active.

Reference is now made to FIG. 2B, which is a schematic block diagram (200) of the system, according to some embodiments of the present disclosure. The system may include, according to some exemplary embodiments, a main controller (202) connected to a control panel (204), a power supply digital interface (206), a track ball (207), an image intensifier (210), a memory (212), an LCD controller (214), a tilt sensor (215) and a transmitter (218) which may transmit a signal to a remote receiving device, for example, a PC (220). The control panel (204) is connected to the power supply digital interface (206). The digital interface (206) combines between main controller (202) and the X-ray power supply (222) which is connected to an X-ray tube (224). The image intensifier (210) is also connected to the memory (212). The LCD controller (214) also connects to an LCD (226).

In operation, according to some embodiments, the main controller (202), which is adapted to manage the entire system and regulate the flow of information from the system memory to the output device, after receiving a signal from the control panel (204), signals the digital interface (206) to activate the X-ray power supply (222) which results in emission of X-ray radiation by the an X-ray tube (224). The X-ray radiation may penetrate an object under inspection and impinge upon the image intensifier (detector) (210), which includes a surface sensitive to X-ray radiation and is capable of converting X-ray energy into electrical signals, whereby the electrical signals are used to build multiple radiographic frames of the object under observation. Each digital radiographic frame obtained may be transferred to the memory (212). In addition, each digital radiographic frame is associated with data relating to its relative position within the whole image of the object under observation, which data is obtained by the track ball (207). The tilt angle may be obtained using the tilt sensor (215). The main controller (202) may be adapted to operate as an image processing controller and may be adapted to combine multiple the radiographic frames using the position data associated with each of the radiographic frames, to produce a static image and to produce a dynamic image superimposed over a static image. The signals representing the images may be transmitted to a remote receiving device, for example, a PC computer (220). The signals representing the images may also be transmitted to an LCD controller (214) and presented on an LCD (226). The LCD may also show the system's menus related to ongoing system operation and displays the object under observation when the system is active.

In accordance with embodiments the device may incorporate a navigation (position determination) system (or subsystem) to “know where it is” at all times so that when the device is in operation, the picture frames it generates are stored and then used to build composite views. In this way, a small image intensifier/detector can produce an effective picture much larger than the field of view provided by the detector itself. In addition, according to other embodiments, the system may thus prevents the exposure of already exposed parts.

According to some embodiments, the navigation (position determination) system (or subsystem) may include one or more of the following systems:

According to some embodiments, the position determination subsystem may include an inertial navigation (positioning) system.

Every object that is free to move in space has six “degrees of freedom”—or ways it can move. There are three linear degrees of freedom (x,y,z) that specify the position of the object and three rotational degrees of freedom (theta (pitch), psi (yaw), and phi (roll)) that specify the attitude of the object. If these six variables are known, it is possible to know where the object is and which way it is pointed. An inertial navigation system provides the position, velocities and attitude of an object by measuring the accelerations and rotations applied to the system's inertial frame. It refers to no real-world item beyond itself.

The Inertial navigation system may include, according to some embodiments, a passive system mounted on the device (for example the C-arm) and may be used to detect motion whenever the device is moved. In this way, the system may store relative spatial coordinates for each frame exposure of the device as it is moved. As the device moves, according to some embodiments, the system may build a composite X-ray image of the individual frames, superimposing each frame exactly where it should be in relation to the object under investigation.

In another embodiment, the position determination subsystem may include a system that transmits positioning information to a sensor mounted on the device (for example the C-arm). Such a system may include multiple transmitters (RF, ultrasound or others) that are mounted either on the subject under investigation, on a stand, or otherwise located within the receiving range of the device's detector. By triangulating the signals from the multiple transmitters, the system may record relative spatial coordinates for each frame exposure of the device as the device is moved. As the device moves, the system may build a composite X-ray image of the individual frames, superimposing each frame exactly where it should be in relation to the object under investigation. According to some embodiments, the device can be used in a moving frame of reference (for example, a moving car or ambulance), since it is not dependent on a “fixed frame of reference” for positioning information.

According to some embodiments, the position determination subsystem may include a receiver adapted to receive a signal from a signal-transmitting element. According to other embodiments, the signal may include a radio frequency (RF), infra-red (IR), ultrasonic signal or any combination thereof.

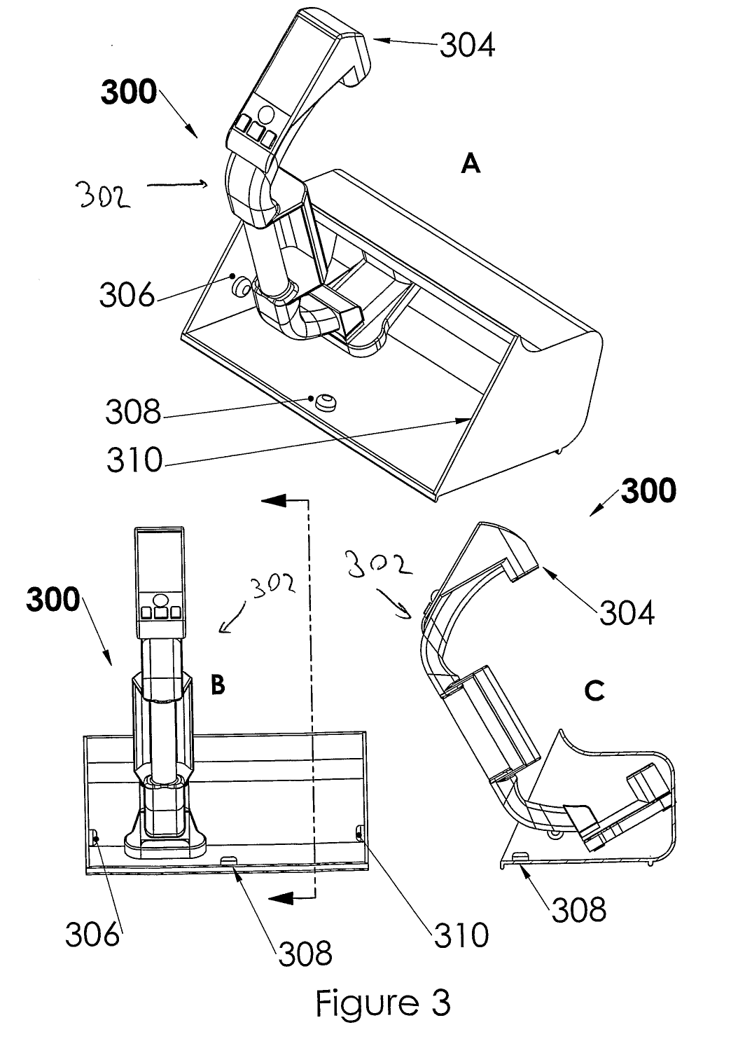

Reference is now made to FIGS. 3 (A-C), which are schematic diagrams of the system from different view points, according to some exemplary embodiments. The system (300) may include a (C-arm shaped) handheld device (302) having a receiver/controller (304) adapted to receive position related signals from a number of transmitters. The system's navigation capabilities are provided by a navigation subsystem that consists of three registration points (306), (308) and (310) each of which contains a transmitter and the receiver/controller (304) that is located on the C-arm. In accordance with some embodiments, the navigation system may be responsible for maintaining the correct spatial location data of at least the following: each static image slice that is generated by the C-arm and up to date (and ongoing) location data of the C-arm, in relation to the object under observation.

According to some embodiments, the position determination subsystem may include a cursor located on the lower or upper part of the device, wherein the cursor is adapted to output a signal proportional to the relative distance done by the cursor. According to other embodiments, the signal may include an electrical signal. According to other embodiments, the relative distance may be measured by mechanical (for example but not limited to, a track ball), optical means (for example but not limited to, IR) or a combination thereof. According to other embodiments, the cursor may be adapted to move on a planar surface. According to other embodiments, the planar surface may further include a stabilizing element adapted to stabilize the object under examination.

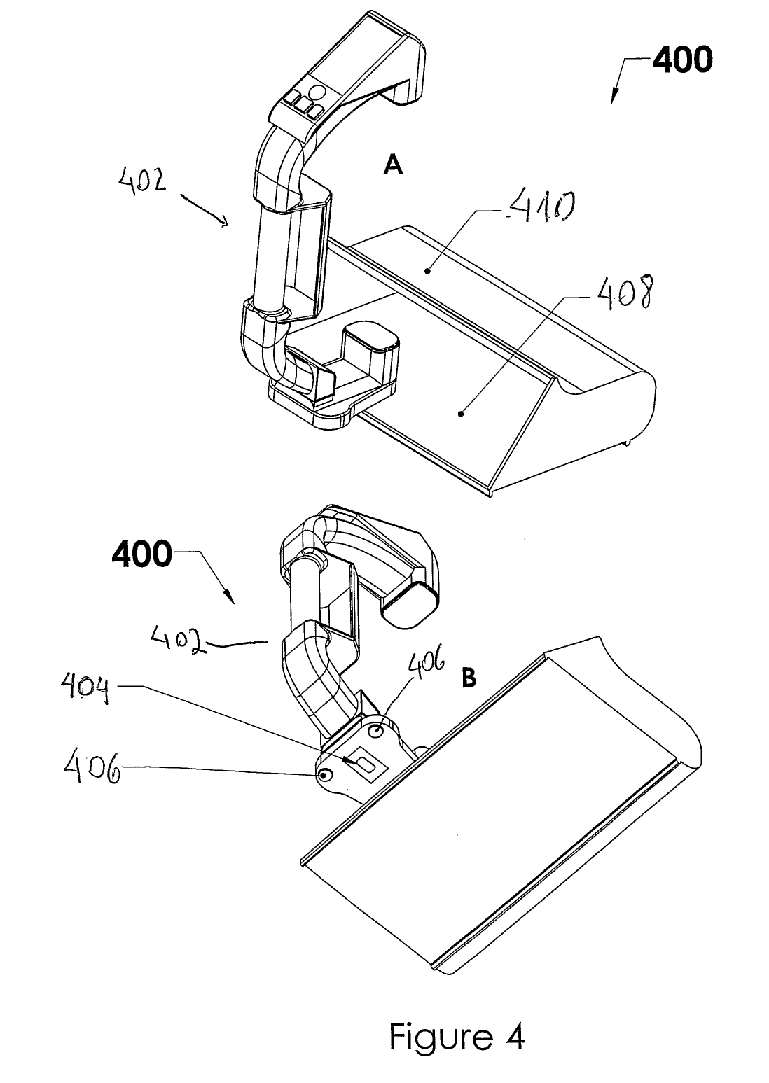

Reference is now made to FIG. 4 (A-B), which are schematic diagrams of the system from two view points, according to some exemplary embodiments. The system (400) may include an X-ray radiographic device (402) as described herein, which includes a cursor (404) and a sliding element (406) adapted to move on a planar surface (408). The planar surface may further include a stabilizing element (410) adapted to stabilize the object under examination.

According to some embodiments, the device may further include a tilt sensor adapted to provide the spatial angle of the device (for example the upper part of the C-arm or the X-ray source) in relation to a certain reference surface or in relation to the object under investigation (for example a hand or leg).

According to some embodiments, the detector (also referred to herein as an image interface) may include an X-ray target, wherein the X-ray target may include an X-ray sensitive element adapted to provide the dynamic image. According to other embodiments, the X-ray sensitive element may include a scintillation screen.

The X-ray sensitive element is capable of converting X-ray energy into electrical signals, whereby the electrical signals are used to build an image of the object under observation (a “meaningful” or as referred to herein, a dynamic image). The interface may be digital, analog or combination thereof and may use either direct or indirect methods for generating an image of the object under observation.

The image interface may be located at one end of the C-arm, in the traditional fashion of conventional C-arms. According to some embodiments, the device may enable the incorporation of a meaningful size of an effective field of view (for example, about 6″) while keeping the device weight low. These set of components used in the detector, according to some embodiments, allows the use of the X-ray data to show a continuous picture.

In one embodiment the term “field of view” may refer to the size of an actual radiographic frame obtained by an intensifier/detector. The field of view, according to some embodiments, may be about 2″. The field of view, according to some embodiments, may be between 1-4″. The field of view, according to some embodiments, may be between 2-4″.

In another embodiment the term “effective field of view” may refer to an image obtained by an intensifier/detector by combining a multiplicity of radiographic frames. The device may thus produce an effective picture (based on an effective field of view) larger than the field of view provided by the detector itself. The device may produce an effective picture (based on an effective field of view), which is theoretically, unlimited in size. The device, according to some embodiments, may produce an effective field of view larger than 5″. The device, according to other embodiments, may produce an effective field of view larger than 6″. The device, according to other embodiments, may produce an effective field of view larger than 10″. The device, according to other embodiments, may produce an effective field of view larger than 12″. The device, according to other embodiments, may produce an effective field of view larger than 15″. The device, according to other embodiments, may produce an effective field of view larger than 20″. The device, according to other embodiments, may produce an effective field of view comparable to those produced by static X-ray cameras which utilizes plates, for example 11″×17″. The device, according to other embodiments, may produce an effective field of view limited only by the memory of the system and by the resolution of the picture.

According to some embodiments, the detector may include a high-resolution semiconductor chip, a flat panel, an image intensifier or any combination thereof. According to other embodiments, the detector may include a selenium-based element. According to other embodiments, the high-resolution semiconductor chip may include a Charged Coupled Device (CCD), CMOS or a combination thereof. According to other embodiments, the flat panel may include an amorphous silicon-based photo sensor. According to some embodiments, the detector may include any direct or indirect. Direct-conversion detectors have an X-ray photoconductor, such as but not limited to, amorphous selenium that directly converts X-ray photons into an electric charge. Indirect-conversion detectors, have a scintillator that first converts X-rays into visible light. That light is then converted into an electric charge by means of photo detectors such as amorphous silicon photodiode arrays or CCDs. Thin-film transistor (TFT) arrays may be used in both direct and indirect conversion detectors. In both direct and indirect conversion detectors, the electric charge pattern that remains after the X-ray exposure is sensed by an electronic readout mechanism, and analog-to-digital conversion is performed to produce the digital image. Any other appropriate X-ray detector may be used, for example detectors disclosed in (http://www.agfa.com/en/he/knowledge_training/technology/direct_indirect_conversion/index.isp) which is herein incorporated by reference.

According to some embodiments, the output of the device may be one or more of the following:

a dynamic image (also referred to herein as a real time image) for example, a fluoroscopic image;

a static image of object under investigation; and

a dynamic image superimposed over a static image of the object under observation.

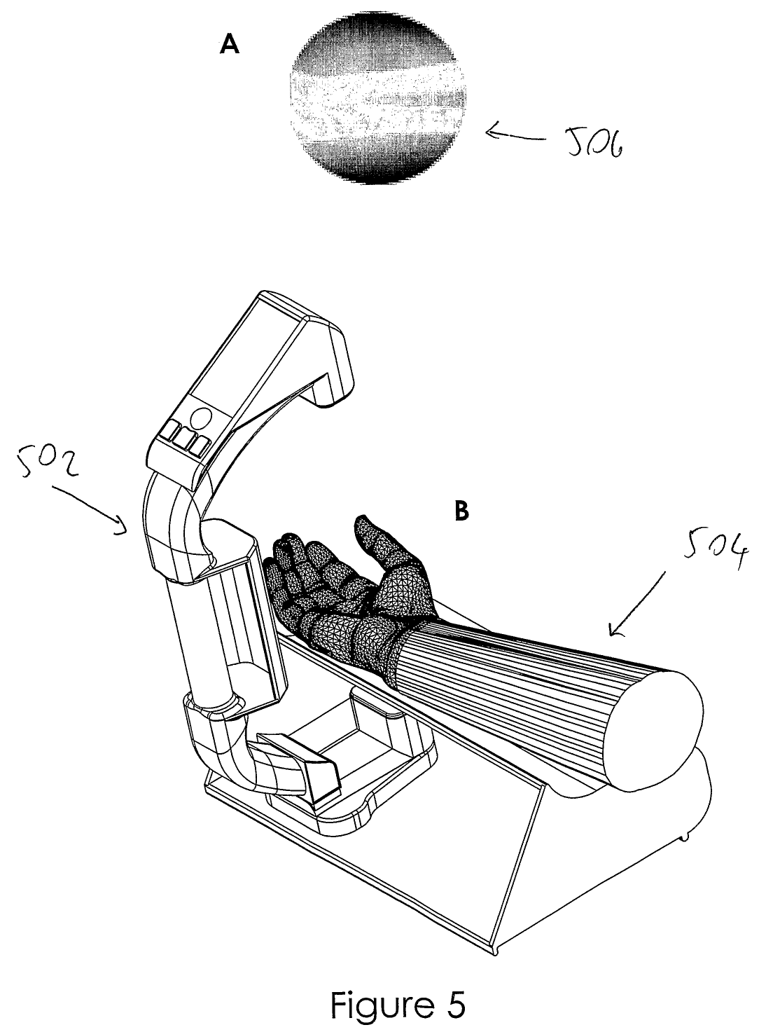

Reference is now made to FIG. 5, which is a schematic diagram of the system (B) and a possible radiographic frame of a dynamic image (A) obtained by the system, according to some embodiments of the present disclosure. The device (502) may scan the object under inspection, for example an arm (504) and provide a radiographic frame of a dynamic image (506).

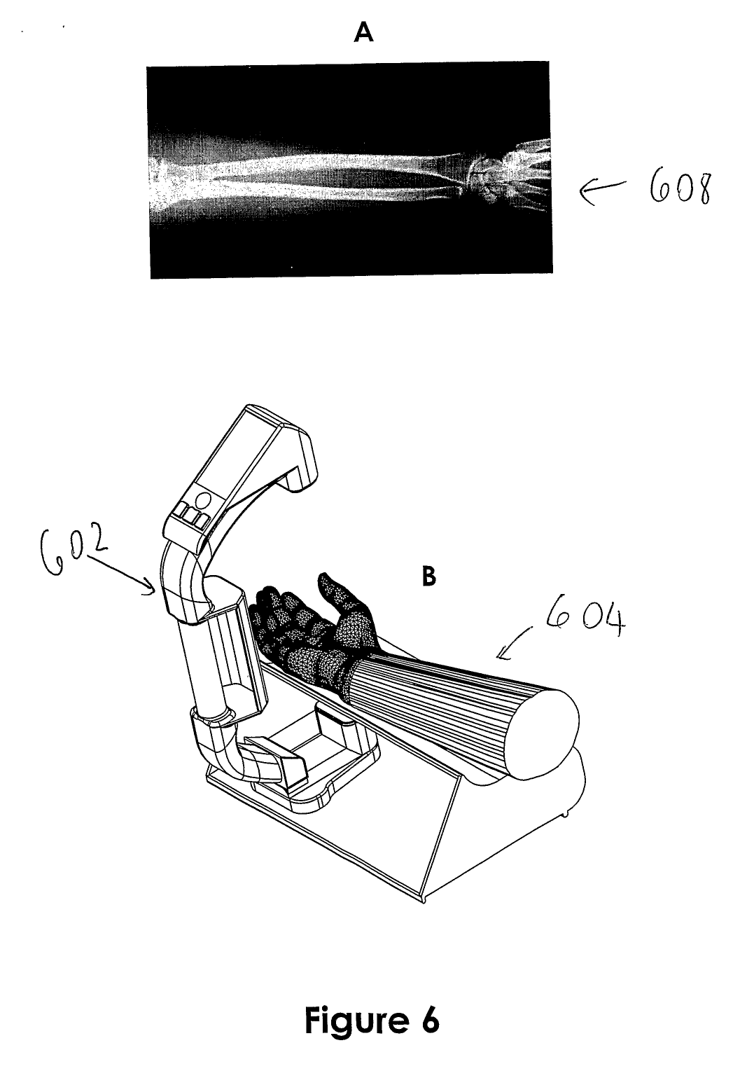

Reference is now made to FIG. 6, which is a schematic diagram of the system (B) and a possible static image (A) obtained by the system, according to some embodiments of the present disclosure. The device (602) may scan the object under inspection, for example an arm (604) and provide a static image (606). The static image (608) may be produced by combining multiple radiographic frames using position data associated with each of the radiographic frames.

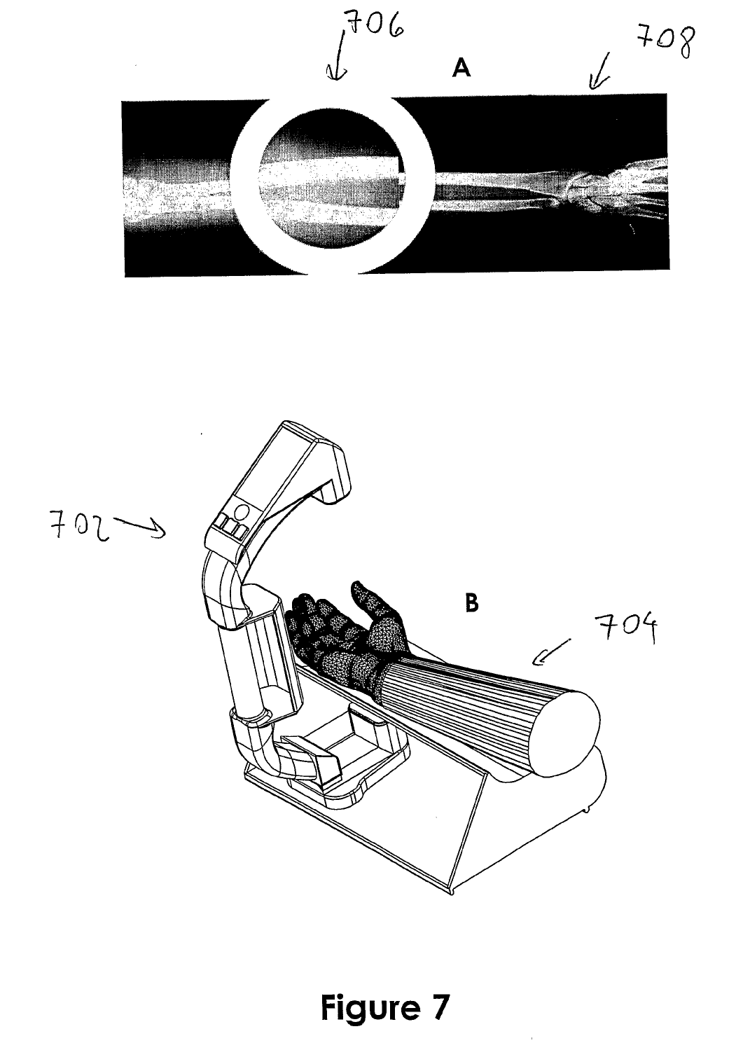

Reference is now made to FIG. 7, which is a schematic diagram of the system (B) and a possible dynamic image superimposed on a static image (A) obtained by the system, according to some embodiments of the present disclosure. The device (702) may scan the object under inspection, for example an arm (704) and provide a dynamic image (706) superimposed on a static image (708).

According to some embodiments, the device may further include a viewing monitor. According to other embodiments, the viewing monitor may be an on-board monitor or a remote monitor.

According to some embodiments, the device may include a liquid crystal display (LCD). According to other embodiments, the LCD may include an operation panel. In another embodiment, the device may include an external output to video monitor. In another embodiment, the device may include an external output to video recorder. In another embodiment, the device may include an external output to computer for further processing.

According to some embodiments, the external image presentation/analysis apparatus may be connected to the device either using standard cables (for example, coax) or may be transmitted via wireless connection, using an appropriate standard (for example, Bluetooth, Wi-Fi, and other means of wireless connection).

According to some embodiments, by passing the information to an external computer, the exemplary following applications (and any other possible application) may be facilitated: bone densiometric measurements of a subject, three-dimensional analysis of X-ray images, image enhancements of X-ray movie, photo montage, other processing of X-ray images and image compression for sending to a remote operator/analyst for further analysis. In one embodiment, the device may include a touch screen LCD monitor on board (on the C-arm, for example) with the device's commands shown directly on the monitor.

In one embodiment, the device provides the ability to offer a predefined set of procedures, so that the operator does not have to manually X-ray and then perform the specific analysis. Rather, the operator may choose a menu item that may configure the C-arm, may take the X-ray, and may post-process the image to provide the necessary output. An example of this would be the device's ability to automatically perform densiometric analyses, without having to do it in several manual steps.

According to some embodiments, the device may further include an X-ray source. According to other embodiments, the X-ray source component may generate the radiation needed to create a fluoroscopic image. In accordance with some embodiments, the X-ray may be a commercially available X-ray tube that may generate the X-ray beam needed to illuminate the object under observation. According to some embodiments, the X-ray tube assembly may be smaller/lighter than X-ray tubes used, for example, in health care centers and therefore, may be more portable.

According to some embodiments, the device may include a power supply element adapted to supply voltage to the X-ray source and to switch the voltage on and off to prevent the X-ray source and the X-ray tube from overheating. According to other embodiments, the X-ray tube may not require cooling. According to other embodiments, the X-ray tube may include an air-cooling mechanism. According to other embodiments, the power supply may be able to provide higher power while being much more electrically efficient than X-ray devices used, for example, in health care centers and therefore, may be more portable.

According to some embodiments, the use of the circuitry described herein may limit the scattered radiation and therefore may reduce the amount of radiation to which the subject and operator are exposed. The device may thus require no lead aprons for the intended applications.

According to other embodiments, the power supply element may provide between 1-70 kVP. According to other embodiments, the power supply element may provide between 10-60 kVP. According to other embodiments, the power supply element may provide between 20-70 kVP. According to other embodiments, the power supply element may provide between 40-70 kVP. According to other embodiments, the power supply element may provide between 10-40 kVP. According to other embodiments, the power supply element may be lower than 30 kVP.

As non-limiting examples, according to some embodiments, the current applied to the X-ray source may be between 0.05-0.5 mA. According to other embodiments, the current applied to the X-ray source may be between 0.05-0.25 mA. According to other embodiments, the current applied to the X-ray source may be between 0.1-0.25 mA. According to other embodiments, the current applied to the X-ray source may be between 0.1-0.2 mA. According to other embodiments, the current applied to the X-ray source may be lower than 0.2 mA.

The control system, according to some embodiments, which may also be referred to herein as a “controller” or “main controller”, may consist, of a user interface panel and the associated control mechanism needed to operate the device, as well as required safety features mandated by law.

The control panel of the device may include one or more of the following, or any combination thereof: switches embedded within the device assembly, a control panel connected to the device via a cable assembly, a control panel connected to the device via a wireless connection (for example, a wireless remote control), a foot switch for turning the device on or off, a foot-operated controller (for example, a mouse or a joystick) for positioning and controlling the device. The operator may also be able to select from system menus using the foot-operated controller. According to some embodiments, the control panel may incorporate any one or combination of the following functionality, or any other appropriate feature: a system power on/off switch, a fluoroscope on/off switch (and/or foot switch, and/or timer that shuts the system off automatically), a voltage selector, a current selector, a voltage and current selector may be combined into one “exposure setting”. In another embodiment, the controller may also contain necessary safety features dictated for devices that generate X-rays. Some functions supported by the control system may include, but not limited to, the following: an automatic shutoff switch that may turn the system off in case the tube or circuitry overheats, a fuse assembly, a voltage limiter, a current limiter or any combination thereof.

According to some embodiments, the device may be adapted to remote control operation. The device (for example, the C-arm) may be controllable by a remote controller (for example, a joystick or mouse). Using the controller (which may be mounted directly on the arm, may be remote controlled, or may be operated by foot), the operator can position the imaging device.

According to some embodiments, the device may include a foot pedal adapted to operate the device at least partially. In one embodiment, the ability to control the device using a foot may be useful in that an operator, for example a surgeon, may be able to use both hands simultaneously and operate the imaging device with their foot. This is especially important to surgeons using the device to assist them during surgery (for example, minimally invasive surgery).

According to some embodiments, the device may be adapted to operate in a non-shielded environment. According to other embodiments, the device may be operated by non-specialized personnel (for example, a person not trained to operate X-ray devices, such as a medic or a paramedic in an accident site).

As part of the present disclosure a method is provided for producing a static image from multiple radiographic frames using a handheld radiographic device, the method may include producing a digital radiographic frame of a dynamic image of an object under investigation, providing position data associated with the digital radiographic frame and combining multiple radiographic frames using the position data associated with each of the radiographic frames to produce a static image.

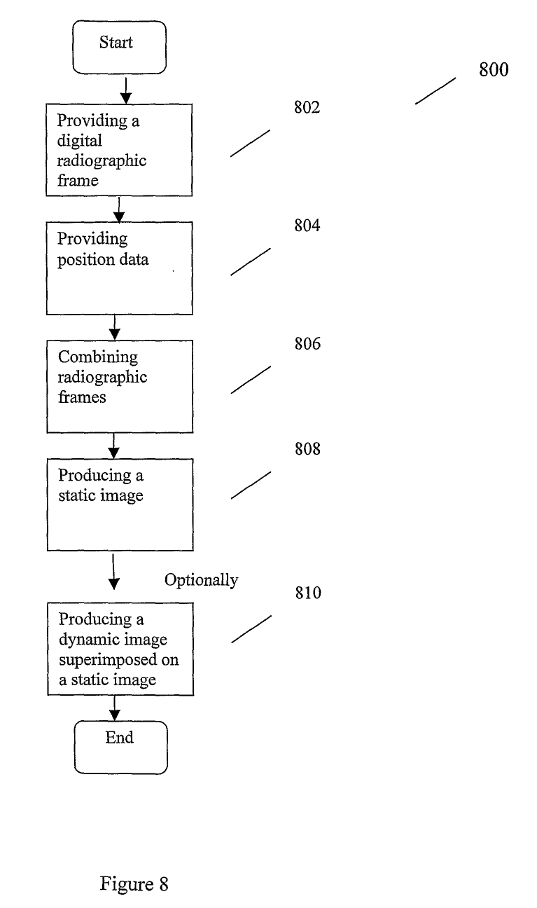

Reference is now made to FIG. 8, which illustrates a flow chart (800) of a method for producing a static image from multiple radiographic frames using a handheld radiographic device, according to some embodiments of the present disclosure. The method may include producing a digital radiographic frame of a dynamic (real time) image of an object under investigation (802), providing position data associated with the digital radiographic frame (804), combining multiple radiographic frames using the position data associated with each of the radiographic frames (806), producing a static image (808) and optionally producing a dynamic image superimposed over a static image (810).

According to some embodiments, the method may further include producing a dynamic image superimposed over a static image. According to other embodiments, the method may include providing position data associated with the digital radiographic frame comprises using an inertial navigation system. According to other embodiments, the method may include providing position data associated with the digital radiographic frame comprises using a receiver adapted to receive a signal from a signal-transmitting element. According to other embodiments, the method may include providing position data associated with the digital radiographic frame comprises using a cursor located on the lower part of the device, wherein the cursor is adapted to output a signal proportional to the relative distance done by the cursor. According to other embodiments, the method may include remotely operating the device. According to other embodiments, the method may include operating the device using a robotic arm.

According to embodiments of the invention, the device may support several modes of operation:

In one embodiment the device may support a dynamic mode of operation. In this mode, the system provides dynamic (for example, fluoroscopic) images in real-time on the on-board monitor or on a remote monitor or storage device. The system may be activated either by a hand or foot switch.

According to an embodiment of the invention, the device may operate like a conventional device in a dynamic mode of operation.

In another embodiment the device may support a “Stills” mode of operation (for producing a still image). In this mode, the operator scans the device across the object of interest. As the device moves (or the object moves in relation to a stationary device), the system records a set of “snapshot” images; each image is a picture of the area currently illuminated by the X-ray beam. At the end of this “scanning” motion, a composite image is built that represents the entire scanned object as one image. The system corrects for non-uniform motion of the operator, as well as inadvertent motion of the patient. There is no need to remain absolutely still during the examination. In this way, the system is able to produce a much larger image of an object than would be provided by conventional device (i.e. a “snapshot” photo using the device is much larger than the size of the detector).

According to an embodiment of the invention, the system may build a composite still image from a set of image “slices.” The system may operate this mode using some registration points (for example three or four) that are located either on the object under observation or on a surface to which the object under observation is affixed (and stationary in respect to this surface). Examples of such a surface may include a splint or support. At each registration point a transmitter is located that generates a signal (either ultrasonic, electronic or optic) that is received by a receiver (and controller) mounted on the device. The receiver and controller calculate the location of the device for every image slice that is generated by the device. For each image captured, the system assigns the spatial coordinates of the image slice. During or following the scan, the system uses the spatial location data to generate a composite image by correctly “pasting” the individual image slices together.

In another embodiment the device may support a “mixed” mode of operation. In this mode the operator is able to view a dynamic (for example, fluoroscopic) image superimposed on top of the still image that was generated by the system (using the “Stills” mode). The system is able to correctly position the dynamic image in the correct place so that the operator is able to see a real-time dynamic image in the appropriate location of the object of interest. In this way, the operator is able to examine a specific point of interest using a dynamic, fluoroscopic image, while maintaining the macroscopic perspective of where the point is located on the scanned object.

According to an embodiment of the invention, the system generates a composite image as described above (“stills mode”). After the image is generated, the operator can use the device to view the object under observation, as described above (“dynamic mode”). In this case, however, the dynamic image appears “superimposed” on the still image generated via the scan. As the operator moves the device, the dynamic image may always be shown correctly superimposed on the object of interest. In this way, the operator can focus on a specific part of the object under observation, while maintaining the macroscopic perspective of where this section appears on the overall object. The system may use the device's navigation capabilities (the position of the C-arm in relation to the object) to correctly position the real-time, dynamic image on top of the previously generated “stills” image.

In one embodiment, the invention provides the ability to offer a predefined set of procedures, so that the operator does not have to manually X-ray and then perform the specific analysis. Rather, the operator may choose a menu item that may configure the C-arm, may take the X-ray, and may post-process the image to provide the necessary output. An example of this would be the device's ability to automatically perform densiometric analyses, without having to do it in several manual steps.

The device, according to some embodiments, may produce an effective field of view that is larger than provided by the source/detector components.

According to other embodiments, the device may produces a real-time, dynamic, fluoroscopic image correctly superimposed on a static image of the object under investigation, so that an operator (such as a physician, an X-ray technician, emergency medical personnel and others) can “drill down” to investigate a specific area on the object, while retaining the macroscopic perspective of the area's location in relation to the object at large. The portable fluoroscope may be practical for point of care and emergency applications.

According to other embodiments, the device may provide the ability to display both a visible photograph superimposed over the X-ray view of the subject. In this way, the viewer can see where on the subject the area of interest is located. For example, if an operator is looking for a broken bone, they can see a photo of the arm superimposed over the X-ray, so they can see where on the body the break has occurred.

According to some embodiments, the device may incorporate the following exemplary characteristics. In one embodiment, the device may be small enough to be portable and self-contained. In another embodiment, portable may mean able to be carried, deployed, and operated by non-specialized radiation personnel. In one embodiment, self-contained may mean that the system is operational without the need for additional external elements (other than those provided in this document). In another embodiment, the device may provide the energy levels and resolution necessary generate images static and dynamic fluoroscopic images that are useful for diagnostic applications. In another embodiment, the device may be safe for use by non-specialized personnel in non-shielded environments, for a number of examinations that are routinely performed by such personnel.

The device may, according to some embodiments, incorporate adjustable arms that may allow the X-raying of items of varying depth. This feature may facilitate the X-raying of different size objects (for example, body parts). In one embodiment, the portable device may enable the adjustment of the “throat depth” (which may be defined, in accordance with some embodiments, as the distance between the X-ray source and the target) in order to conform to the requirements of a specific object under inspection. In one embodiment, the portable device may enable a motion that increases/decreases the distance between the X-ray tube and the target (detector), as well as changes the “throat depth” of the device (for example, a C-arm) to get around large object. In accordance with some exemplary embodiments, the throat depth may be between 5-20″. In accordance with other exemplary embodiments, the throat depth may be between 10-19″. In accordance with other exemplary embodiments, the throat depth may be between 12-17″. In accordance with other exemplary embodiments, the throat depth may be about 15″.

The device may open and close like a clam around an object that represents an obstacle to X-raying the subject. According to some embodiments, the controller may be adapted to turn off the power supply to the X-ray source if the distance between the X-ray source and the object under inspection decreases below a predetermined value.

According to some embodiments, the device may further include a tilt sensor adapted to provide the spatial tilt angle. The tilt angle may be, according to some embodiments, the angle between the device (for example the upper part of the C-arm or the X-ray source) and a certain reference surface such as of the object under investigation (for example a hand or leg). According to some embodiments, the controller may be adapted to turn off the power supply to the X-ray source if the tilt angle is higher than a predetermined value. In one embodiment, the predetermined value may be 92°. In another embodiment, the predetermined value may be 95°. In another embodiment, the predetermined value may be 100°. According to some embodiments, the controller may be adapted to turn off the power supply to the X-ray source if the tilt angle is lower than a predetermined value. In one embodiment, the predetermined value may be 87°. In another embodiment, the predetermined value may be 85°. In another embodiment, the predetermined value may be 80°.

In accordance with some exemplary embodiments the weight of the device may be between 5-15 lbs. In accordance with other exemplary embodiments the weight of the device may be between 7-10 lbs. In accordance with other exemplary embodiments the weight of the device may be lower than 10 lbs. In accordance with other exemplary embodiments the weight of the device may be lower than 7 lbs. In accordance with other exemplary embodiments the weight of the device may be lower than 5 lbs.

According to some embodiments, the portable device may provide image analysis as part of the system output. Examples of image analysis include, but are not limited to, bone densiometry, image enhancement, compression for transmitting the images wirelessly to a remote terminal.

According to other embodiments, scales (linear, angular or both) can be viewed on the device's display. Thus, the display may allow the operator measure distances or angles between multiple points of interest on the subject, directly on the screen. The scales may also be saved with the photo so that it can be printed out or used for later analysis.

According to other embodiments, the system may include a “back off” function that may allow an operator X-ray a subject and then move the device out of the way. A subsequent command may return the device to precisely the position and orientation that existed prior to the “back off” command. This feature may be useful for surgeons, performing operations, for example, where they want to be able to remove the device momentarily (for example, so that they can position themselves better with respect to the patient). Once they want to view the subject again, the device may be returned to its original position without having to do any manual manipulation. This feature may be controlled by the foot controller so that the surgeon can keep both hands available for the operation.

In one embodiment, the device may be structured as a C-arm which is named a C-arm because of the representative shape of the assembly (which resembles the letter “C”). Typically, X-ray C-arm devices which are named C-arms because of the representative shape of the assembly (which resembles the letter “C”) may be mounted on a stationary assembly that facilitates manipulation in order to view a wide range of body parts. In general, according to some embodiments, the C-arm mechanical assembly may serve any one the following purposes or any combination thereof. The C-arm mechanical assembly may house the X-ray source assembly, properly position the source and target assemblies, house the monitoring and diagnostic components (for example, CCD camera, LCD viewing monitor, output ports for external monitoring and diagnostic equipment, and other elements), provide for the positioning and manipulation of the X-ray device (which may include at least one of hand grips for holding and manually positioning the device and mounting bracket for connecting the C-arm to a stationary platform or mobile apparatus that manipulates and maintains the position of the C-arm during operation, provide the controls for the X-ray device (the control may optional be operational via remote control, depending on the application) and provides a safe environment for radiological examination (for the subject and for the operator). The basic C-arm assembly may a mechanical assembly that may facilitate the functionality described herein.

In accordance with some embodiments, there may be several other features built into the C-arm mechanical assembly for example, onboard video monitor (via LCD screen for example) built onto the C-arm itself. In accordance with other embodiments, the device may include certain materials (such as but not limited to, titanium) to achieve extremely lightweight assembly, so that device is usable by non-specialized personnel.

According to some embodiments, the device, which may be shaped as a C-arm may incorporate a unique support stand that may allow the operator to use the radiograph without having to hold it in place. The device may be operated using one hand or alternatively using no hands (operating the device using the foot controller, or possibly a head up display), so that the operator can view the subject in three-dimensions while the hands free for other tasks. According to some embodiments, the support stand may support a linear motion and a rotational motion. According to some embodiments, the support stand may include a docking station.

A linear motion, according to some embodiments, may allow an operator to traverse or scan an object. For example, a physician can take a continuous X-ray of a patient's forearm. Furthermore, the system may automatically build a composite photo from different frames of the fluoroscopic movie made while the device scans the object.

Rotational motion, according to other embodiments, may permit a complete 360° rotation along two axes (simultaneously). This allows the operator to develop a three-dimensional view of the subject at hand. Imaging software supplied with the device may present a three-dimensional view of the object under observation for detailed analysis. The C-arm may of course, disengage from the C-arm stand so that it can be used in a free-standing position by the operator.

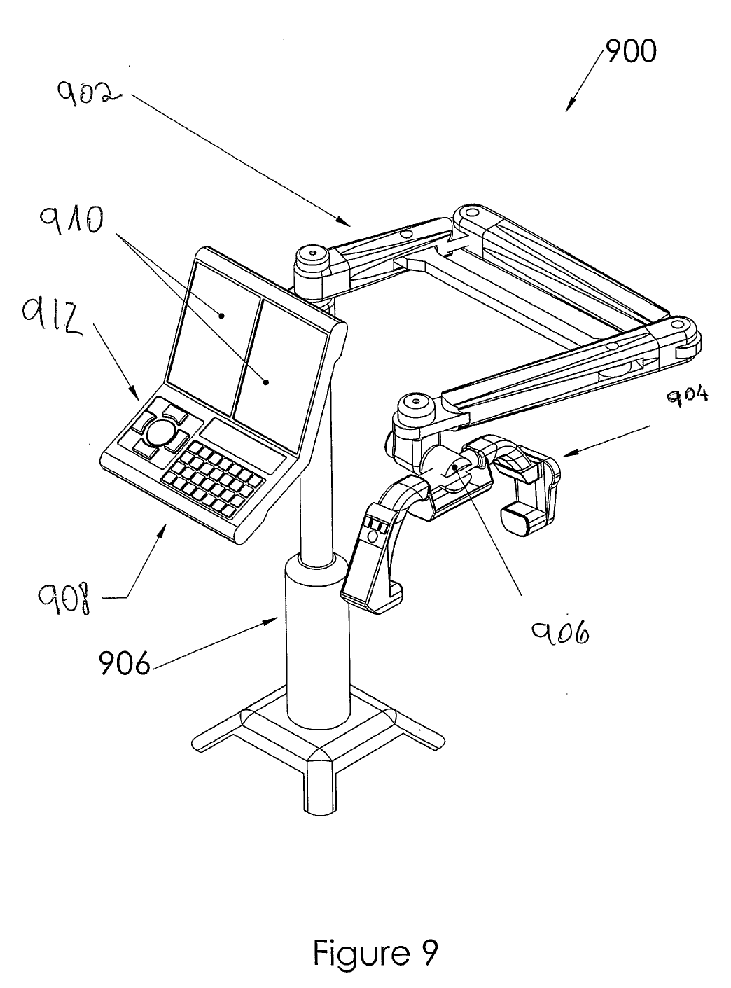

According to some embodiments, the device may include a robotic arm. According to some embodiments, the device, which may be shaped as a C-arm may include a robotic arm that may be able to accurately position the device, for example, in minimally invasive procedures. According to some embodiments, the following functionalities of the device's robotic arm may be achieved. The device may be moved in and out of position with a “memory” command that remembers where the device was located before it was removed. The device may be controlled via a foot “mouse” that may move the device according to the operator's foot motion. The device may be controlled by following the motion of tools that are held by the operator. Therefore, as the operator moves a tool (for instance a scalpel, a needle or any other tool used during a medical procedure) relative to the subject under investigation, the device may move in order to illuminate that specific place in space. A schematic diagram of a system, which may be operated using a robotic arm, is shown in FIG. 9, according to some embodiments. The system (900) includes a robotic arm (902) connected to an X-ray radiographic device as described herein, for example a C-arm (904). The robotic arm (902) is connected to the C-arm using a gripper (906). The system may be operated by the control subsystem (908) which may include a monitor, for example, a two screen monitor (910) and a control panel (912) which may include a key pad and a track ball.

According to additional embodiments, some add-ons to the device may include a suitcase that incorporates a viewing screen for true mobility. The device can be kept in a hardened case and taken to the field. Once there, the operator can view a large picture by flipping up the top of the case and viewing the picture on the screen. Connections to this monitor can be done using wires or via a wireless technology.

According to additional embodiments, add-ons to the device may include a plastic covers surgery. In another embodiment, add-ons to the device may include a foot pedal or trigger pull. In another embodiment, add-ons to the device may include dual screen operators. In another embodiment, add-ons to the device may include a stand. In another embodiment, add-ons to the device may include a robotic arm that may change the geometry of the C-arm to view objects of different dimensions (e.g. thicker or wider). In another embodiment, add-ons to the device may include markers that may be placed on the object under observation, so that the unit can synchronize the position of the object with the real-time fluoroscopic view.

Non-limiting examples of applications for the device include but not limited to medicine, orthopedic applications (extremities), veterinary medicine (including equine), sports medicine, military medicine, emergency medicine, geriatric medicine, security (including on-site package inspection and screening), industry (including inspection of welds and the structural integrity of objects including for example, aviation components, marine vessels, supports, large immobile structures such as buildings, pipes, electronic components and assemblies) and any other relevant application.

What we claim is:

1. A handheld radiographic device comprising:
an X-ray detector adapted to provide a digital radiographic frame of a dynamic image of an object under investigation;
a position determination subsystem adapted to provide position data associated with a digital radiographic frame; and
an image processing controller adapted to combine multiple radiographic frames using the position data associated with each of the radiographic frames and to produce a static image.

2. The device of claim 1, wherein said controller is further adapted to produce a dynamic image superimposed over a static image.

3. The device of claim 1, wherein said position determination subsystem comprises an inertial navigation system.

4. The device of claim 1, wherein said position determination subsystem comprises a receiver adapted to receive a signal from a signal-transmitting element.

5. The device of claim 4, wherein said signal comprises a radio frequency (RF), infra-red (IR), ultrasonic signal or any combination thereof.

6. The device of claim 1, wherein said position determination subsystem comprises a cursor located on the lower part of said device, wherein said cursor is adapted to output a signal proportional to the relative distance done by said cursor.

7. The device of claim 6, wherein the relative distance is measured by mechanical, optical means or a combination thereof.

8. The device of claim 6, wherein said cursor is adapted to move on a planar surface.

9. The device of claim 6, wherein said planar surface further comprises a stabilizing element adapted to stabilize the object under examination.

10. The device of claim 1, wherein said detector comprises an X-ray target, wherein said X-ray target comprises an X-ray sensitive element adapted to provide the dynamic image.

11. The device of claim 10, wherein said X-ray sensitive element comprises a scintillation screen.

12. The device of claim 1, wherein said detector comprises a high-resolution semiconductor chip, a flat panel, an image intensifier or any combination thereof.

13. The device of claim 1, wherein said detector comprises a selenium-based element.

14. The device of claim 12, wherein said high-resolution semiconductor chip comprises a CCD, CMOS or a combination thereof.

15. The device of claim 12, wherein said flat panel comprises an amorphous silicon-based photo sensor.

16. The device of claim 1, further comprising an X-ray source.

17. The device of claim 1, adapted to remote control operation.

18. The device of claim 1, further comprising a viewing monitor.

19. The device of claim 1, wherein said viewing monitor is an on-board monitor or a remote monitor.

20. The device of claim 1, adapted to operate in a non-shielded environment.

21. The device of claim 1, further comprising a foot pedal adapted to operate said device at least partially.

22. The device of claim 1, further comprising a liquid crystal display (LCD).

23. The device of claim 22, wherein said LCD comprises an operation panel.

24. The device of claim 1, wherein said device comprises a C-arm shaped element.

25. The device of claim 1, further comprising a robotic arm.

26. A method for producing a static image from multiple radiographic frames using a handheld radiographic device, the method comprising:
producing a digital radiographic frame of a dynamic image of an object under investigation;
providing position data associated with the digital radiographic frame; and
combining multiple radiographic frames using the position data associated with each of the radiographic frames to produce a static image.

27. The method of claim 26, further comprising producing a dynamic image superimposed over a static image.

28. The method of claim 26, wherein providing position data associated with the digital radiographic frame comprises using an inertial navigation system.

29. The method of claim 26, wherein providing position data associated with the digital radiographic frame comprises using a receiver adapted to receive a signal from a signal-transmitting element.

30. The method of claim 29, wherein said signal comprises a radio frequency (RF), infra-red (IR), ultrasonic signal or any combination thereof.

31. The method of claim 26, wherein providing position data associated with the digital radiographic frame comprises using a cursor located on the lower part of said device, wherein said cursor is adapted to output a signal proportional to the relative distance done by said cursor.

32. The method of claim 31, wherein the relative distance is measured by mechanical, optical means or a combination thereof.

33. The method of claim 31, wherein said cursor is adapted to move on a planar surface.

34. The method of claim 31, wherein said planar surface further comprises a stabilizing element adapted to stabilize the object under examination.

35. The method of claim 26, further comprising remotely operating the device.

36. The method of claim 26, further comprising operating the device using a robotic arm.
